(19) United States
(12) Patent Application Publication
(10) Pub. No.: US 2015/0363229 A1
(43) Pub. Date: Dec. 17, 2015

(54) RESOLVING TASK DEPENDENCIES IN TASK QUEUES FOR IMPROVED RESOURCE MANAGEMENT

(71) Applicant: Futurewei Technologies, Inc., Plano, TX (US)

(72) Inventor: Zhuang WANG, San Jose, CA (US)

(21) Appl. No.: 14/302,246

(22) Filed: Jun. 11, 2014

(51) Int. Cl. G06F 9/48; G06F 17/30; G06F 9/50

(52) U.S. Cl. CPC G06F 9/4881; G06F 9/5088; G06F 9/5011; G06F 17/3056

(57) ABSTRACT

A database system comprises a database server and a database storage system comprising a storage processing node and a queue. The database server is operable to define a priority for each of a plurality of database tasks. The storage processing node is operable to receive database tasks from the database server and place them into the queue based upon their priority. The storage processing node is further operable to determine whether there are dependencies between a first database task and a second database task with a previously defined higher priority so that the storage processing node is operable to place the first database task into a same queue as the second database task. The second database task is dependent upon the first database task when an input of the second database task is waiting for an output of the first database task.

### TECHNICAL FIELD

The present disclosure relates generally to the field of database resource management and more specifically to the field of database task queue management for efficient database processing.

### BACKGROUND

In a conventional database management system 100, illustrated in FIG. 1, a database server 102 receives and passes on database tasks to a storage system 102. The storage system 102, illustrated in FIG. 1, may include one or more storage devices 112 configured to store database tables. Such database tasks may include read only and read/write tasks that access selected database tables. A database task may also include data queries, data updates, data insertions, and database table modifications, to name a few.

As illustrated in FIG. 1, a storage system 104 may also include a storage processing node 106 that locally processes the database tasks. Such a storage processing node 106 may allow a database server 102 to offload some of its database processing workload to the storage processing node 106. In other words, such a database system 100 may provide for offloading of database tasks to a local storage processing node 106, or the database server 102 may execute the database tasks on the database tables itself. However, a bandwidth between the database server 102 and the storage processing node 106 is often limited and the storage processing node 106 may also have limited processing capabilities. As a result, database tasks may bottleneck or deadlock at the storage processing node 106, with the result that database tasks could be delayed or even killed, resulting in a poor user experience. For example, a needed database task may have to wait for a long running lower priority database task to complete before the needed database task may be executed. Sometimes the delay may be sufficient to affect the quality of service when a needed database task is delayed or even killed.

Therefore, in the database system 100, illustrated in FIG. 1, a resource management process may be used. For example, under such a resource management process, the database server 102 can decide priorities for each database task before the database tasks are sent to the storage processing node 106. As also illustrated in FIG. 1, when database tasks are received by the storage processing node 104, the database tasks may be placed into a queue 108. Database tasks may be placed into the queue 108 in a particular order depending on a current resource management process plan that attempts to keep the disk(s) of the database storage system 104 busy and efficient. However, as discussed herein, efficiency concerns remain, as database tasks may still bottleneck or deadlock even when queued.

### SUMMARY OF THE INVENTION

This present disclosure provides a solution to the challenges inherent in managing multiple database tasks with dependencies in a multiple queue system. In a database system according to one embodiment of the present disclosure, a database system comprising a database server and a database storage system comprising a storage processing node and a queue is disclosed. The database server is operable to define a priority for each of a plurality of database tasks. The storage processing node is operable to receive database tasks from the database server and place them into the queue based upon their priority. The storage processing node is further operable to determine whether there are dependencies between a first database task and a second database task with a previously defined higher priority so that the storage processing node is operable to place the first database task into a same queue as the second database task. The second database task is dependent upon the first database task when an input of the second database task is waiting for an output of the first database task.

In a method according to one embodiment of the present invention, a method for managing database resources is disclosed. The method comprises defining a priority for a first database task. After defining a priority for the first database task, a determination is made as to whether there is another database task with a priority higher than the priority of the first database task that is dependent upon the first database task. Finally, a new priority is set for the first database task that is higher than a priority of a second database task when the second database task depends upon the first database task.

In a method according to another embodiment of the present disclosure, a method for managing database resources is disclosed. The method comprises scanning database tasks held in a plurality of queues for dependencies between the database tasks. Next, priorities of the database tasks are adjusted based upon the determined dependencies. Finally, queue positions of the database tasks are adjusted based upon the adjusted priorities of the database tasks.

### BRIEF DESCRIPTION OF THE DRAWINGS

The present disclosure will be better understood from the following detailed description, taken in conjunction with the accompanying drawing figures in which like reference characters designate like elements and in which:

FIG. 1 illustrates a block diagram of an exemplary database system in accordance with an embodiment of the present disclosure;

FIG. 2A illustrates a block diagram of an exemplary database management system in accordance with an embodiment of the present disclosure;

FIG. 2B illustrates a block diagram of an exemplary database management system in accordance with an embodiment of the present disclosure;

FIG. 3A illustrates a block diagram of an exemplary database management system in accordance with an embodiment of the present disclosure;

FIG. 3B illustrates a block diagram of an exemplary database management system in accordance with an embodiment of the present disclosure;

FIG. 4A illustrates a block diagram of an exemplary database management system in accordance with an embodiment of the present disclosure;

FIG. 4B illustrates a block diagram of an exemplary database management system in accordance with an embodiment of the present disclosure;

FIG. 5 illustrates a flow diagram, illustrating computer executed steps to a method in accordance with an embodiment of the present disclosure; and

FIG. 6 illustrates a flow diagram, illustrating computer executed steps to a method in accordance with an embodiment of the present disclosure.

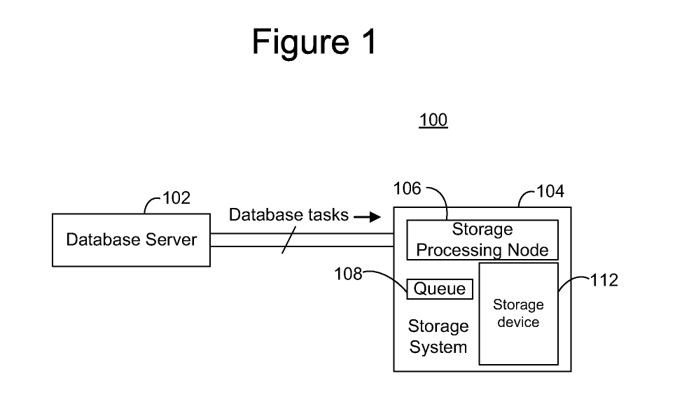

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments described herein may be discussed in the general context of computer-executable instructions, such as program modules, residing on some form of computer-readable storage medium executed by one or more computers or other devices. By way of example, and not limitation, computer-readable storage media may comprise non-transitory computer-readable storage media. Non-transitory computer-readable storage media includes all computer-readable media except for a transitory, propagating signal. Computer-readable storage media includes volatile and nonvolatile, removable and non-removable media implemented in any method or technology for storage of information such as computer-readable instructions, data structures, program modules or other data. Generally, program modules include routines, programs, objects, components, data structures, etc., that perform particular tasks or implement particular abstract data types. The functionality of the program modules may be combined or distributed as desired in various embodiments.

### Resolving Task Dependencies in Task Queues:

Embodiments of this present disclosure provide solutions to the increasing challenges inherent in database task management by resolving task dependency issues for tasks stored in one or more queues. Various embodiments of the present disclosure provide task scanning to detect high priority database tasks with low priority database task dependencies. As discussed in detail below, once a low priority database task with an output required by a high priority database task has been detected, the low priority database task will be placed into the same queue with its corresponding dependent high priority database task so that the low priority database task is in front of the dependent high priority database task.

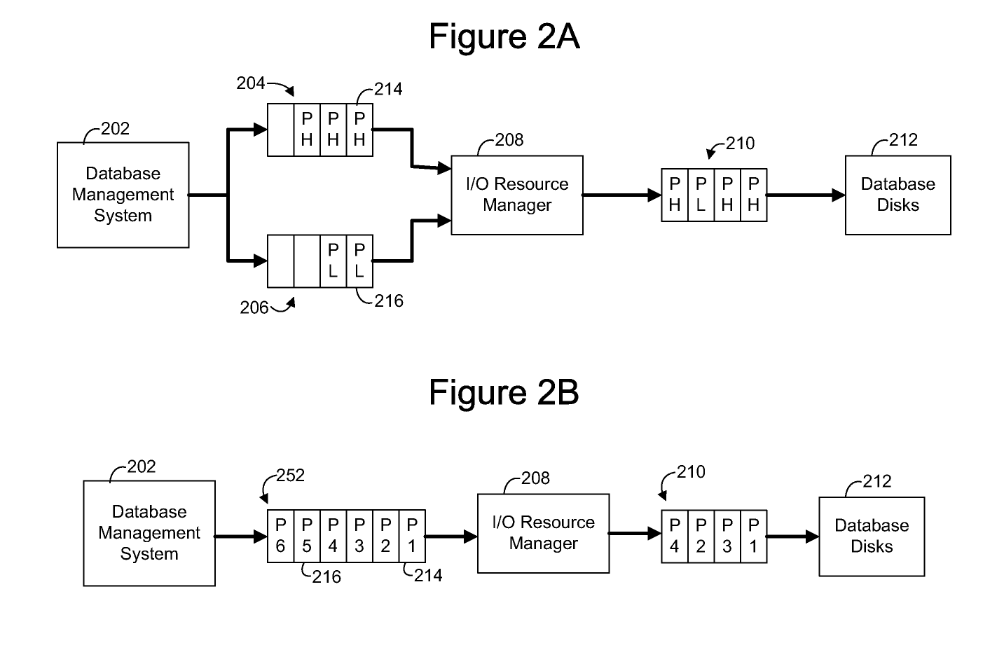

FIG. 2A illustrates a block diagram of a database management system that assigns priorities to database tasks before they are placed into queues. As illustrated in FIG. 2A, the single queue 108 may be replaced with multiple queues 204, 206. In one exemplary embodiment, queue 204 is a high priority queue while queue 206 is a low priority queue. The database management system 202 (which may be implemented in exemplary database servers 102) may define priorities for each database task.

In one embodiment, static database task priority assignments may be assigned by default, based upon database task type and/or database task requester/user, such that database tasks identified as high priority database tasks are placed into the high priority task queue 204 while database tasks identified as low priority database tasks are placed into the low priority task queue 206. There are a variety of methods that may be used to determine whether a database task is to be considered a high priority or a low priority. For example, OLTP tasks may be always considered high priority, while OLAP tasks may be always considered low priority tasks. Additionally, database tasks requested by certain users may be always considered high priority, while database tasks requested by certain other users may always be considered low priority.

As illustrated in FIG. 2A, after the database tasks are placed into queues (204 & 206), an input/output (I/O) resource manager 208 (which may be implemented by an exemplary storage processing node 106) issues I/O requests to send the queued database tasks to the database disks 212 in a manner to ensure the storage disks 212 are kept busy and efficiently processing the database tasks. In one exemplary embodiment, the I/O resource manager 208 may select a database task from either queue (204 & 206) to be sent to the database disks 212 for execution based upon a database management plan. In one exemplary embodiment, a percentage from each queue 204, 206 may be selected based upon the database management plan. The queued database tasks selected from the high priority queue 204 and the low priority queue 206 for execution in the database disks 212 may be represented by an I/O request queue 210. In one exemplary embodiment, the I/O request queue 210 is the high priority queue 204 followed by the low priority queue 206.

FIG. 2B illustrates a block diagram of a database management system that assigns numerical priorities to database tasks before they are placed into a queue 252. As illustrated in FIG. 2B, the pair of queues (204 & 206) illustrated in FIG. 2A, may be replaced with a single queue 252 when the database management tasks are prioritized into a particular order. In one embodiment, database tasks may be statically prioritized and placed into the queue 252: OLTP database tasks may be given a “high” priority, OLAP database tasks may be considered “medium” priority tasks, while development/test database tasks may be given a “low” priority.

In a further embodiment, database task priorities may be dynamically determined by setting a priority for each database task. For example, the database management system 202 (as implemented by the storage processing node 106) can analyze a database task workload at first, and define the properties of CPU time, Disk I/O limitations, a number of parallel tasks, response times, for example, for each particular task. Based on that dynamic definition, a particular database task priority can be set. (“high” priority, “medium” priority, “low” priority, or some numerical priority value. Therefore, the shorter the CPU time, the lower the disk I/O limitations, the fewer the number of parallel tasks, and the quicker the response time, the higher a database task's priority will be.

As discussed herein, a user experience may be improved by placing the database tasks into a single queue 252 with a classification (e.g., low, medium, or high) or numerical order (e.g. 1-100), or by placing the database tasks into a plurality of queues (204 & 206) and dividing them according to priority rating (e.g., a high priority queue and a low priority queue). However, there may still be potential difficulties. Should a high priority database task begin execution that is waiting for an input from a low priority database task that is yet to complete, the high priority database task may hang as the waited for input from the low priority database task is not delivered (because the low priority database task is still waiting to be executed). When a database task hangs as discussed herein (also considered a “runaway” database task), the database task will be killed, resulting in a poor user experience.

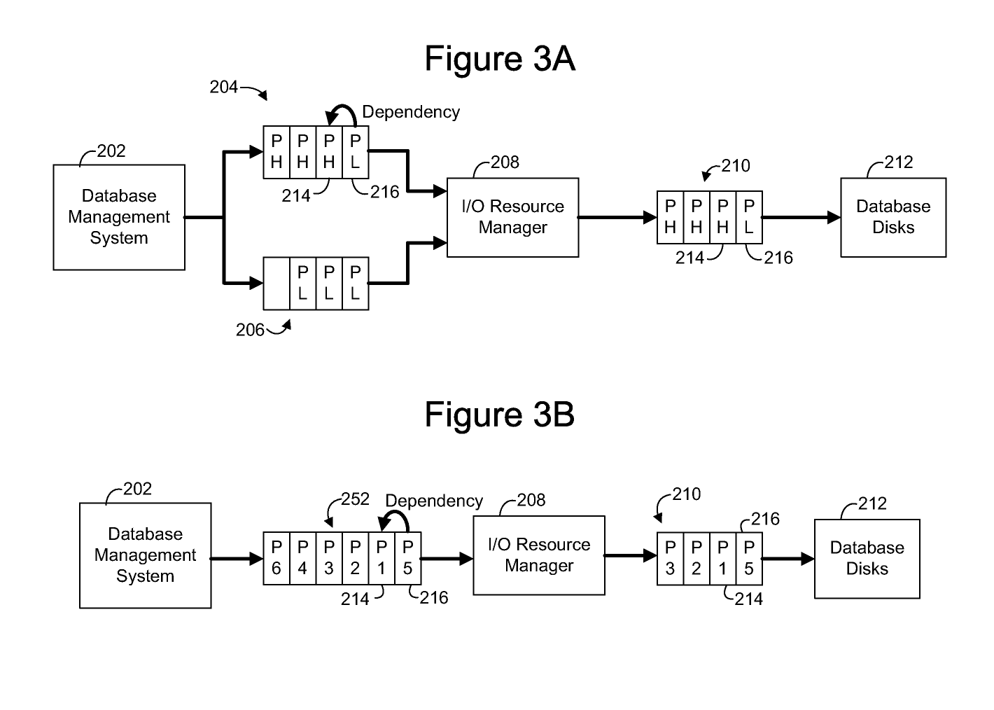

As illustrated in FIGS. 3A and 3B, while database tasks are being prioritized before they are placed into the one or more queues (204 & 206 and 252), the database tasks may also be scanned for dependencies. As discussed herein, a dependency exists when an input to a high priority task 214 is dependent upon, and waiting for, an output from a lower priority task 216. As illustrated in FIGS. 3A and 3B, a high priority task 214 has a dependency upon a lower priority task 216. As also discussed herein, such a dependency may be an input to the high priority task 214 provided by an output of the low priority task 216. In one embodiment, higher priority database tasks are scanned for input dependencies and the lower priority database tasks are scanned for outputs. These inputs and outputs are compared to see if there is a match. In other words, it is determined whether there is an output of a particular low priority database task that provides an input that a higher priority database task is waiting for.

As also illustrated in FIGS. 3A and 3B, when such a dependency has been identified, the database management system 202 may take this dependency into account when the queues (204 & 206 and 252) of database tasks are filled, such that the lower priority database task 216 is placed into the queue 204, 252 ahead of the dependent high priority task 214. In one embodiment, the lower priority task 216 with the needed output may be flagged such that it is placed first in the high priority queue 204 so that it can be queued 210 up first for execution in the database disks 212. As also illustrated in FIGS. 3A and 3B, the I/O resource manager 208 may also send database tasks from the queues (204 & 206 and 252) to the database disks 212 for execution. As discussed previously, the selected tasks from the queues (204 & 206 and 252) may also be placed into an I/O request queue 210. In another exemplary embodiment, the I/O request queue 210 are queues 204 & 206 or 252. In other words, the I/O resource manager 208 may rearrange as needed, the prioritized database tasks stored in the queues (204 & 206 and 252) for delivery to the database disks 212 for execution. As also discussed herein, the activities of the I/O resource manager 208 may be implemented by the storage processing node 106.

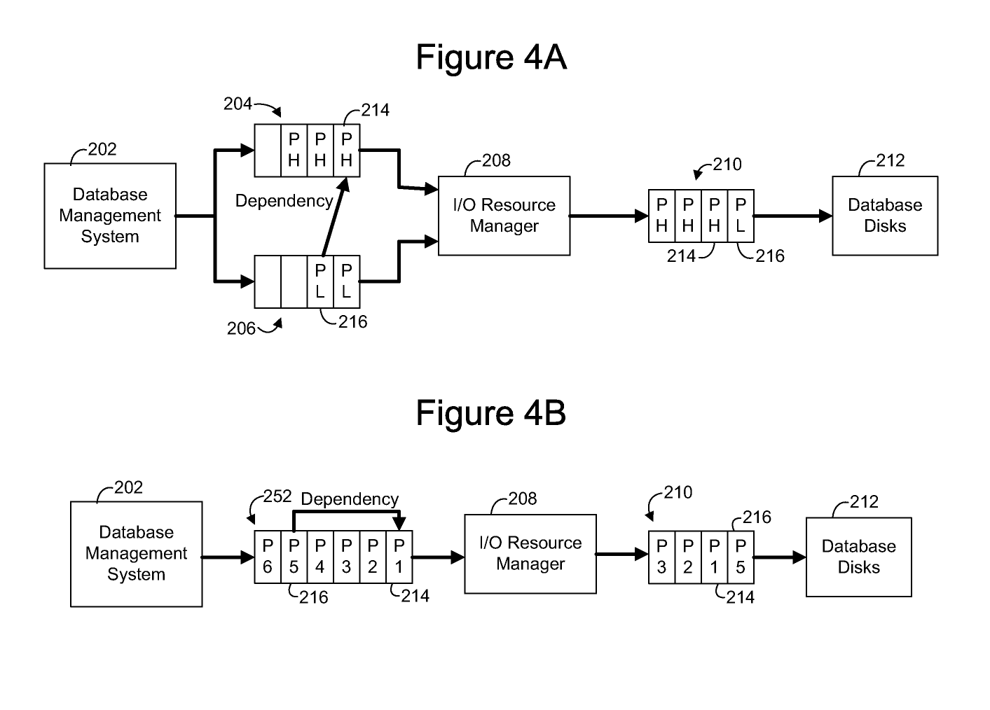

As illustrated in FIGS. 4A and 4B, queues filled with prioritized database tasks may be scanned for dependencies. In one embodiment, the database tasks may have been previously scanned for dependencies before they were placed into the queues (204 & 206 and 252), and then scanned again for dependencies. In one embodiment, the database tasks were not scanned for dependencies when the database tasks were prioritized and placed into the queues (204 & 206 and 252). Therefore, as illustrated in FIGS. 4A and 4B, higher priority database tasks 214 may be found with dependencies to lower priority database tasks 216. As illustrated in FIGS. 4A and 4B, after the dependencies are identified, the I/O resource manager 208 (implemented by the storage processing node 106) may rearrange the database tasks such that when the tasks are output 210 to the database disks 212 the lower priority database tasks 216 (with outputs that higher priority database tasks 214 are dependent upon) will be placed into the queue 210 ahead of the higher priority database tasks 214. In one exemplary embodiment, as illustrated in FIGS. 3A and 3B, the higher priority database tasks 214 and their related lower priority database tasks 216 that they are related to may be rearranged in the queues (204 & 206 and 252) such that the lower priority database tasks 216 are placed in the queue 204 and 252 ahead of their related higher priority database task 214. In other words, the database tasks queued in queues 204 & 206 and 252 may be reorganized according to detected dependencies such that queue 210 represents an order that the database tasks will be queued for delivery to the database tasks 212 for execution. Therefore, queue 210 isn't necessarily a separate queue and may be merely the reordering of database tasks queued for delivery to the database disks 212 in queues 204 & 206 and 252.

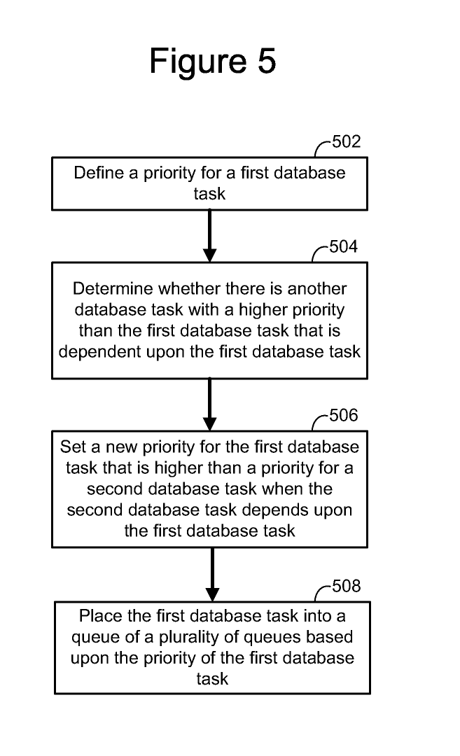

FIG. 5 illustrates the computer executed steps to a process for resolving database task dependencies in task queues. In step 502 of FIG. 5, a priority is determined for a first database task. In step 504 of FIG. 5, it is determined whether there is another database task with a higher priority than the first database task that is dependent upon the first database task. In one exemplary embodiment, the task dependency determination is made before the database task has been placed into a queue.

In step 506 of FIG. 5, a new priority is set for the first database task that is higher than a priority for a second database task when the second database query depends upon the first database task. In step 508 of FIG. 5, the first database task is placed into a queue of a plurality of queues based upon the new priority of the first database task.

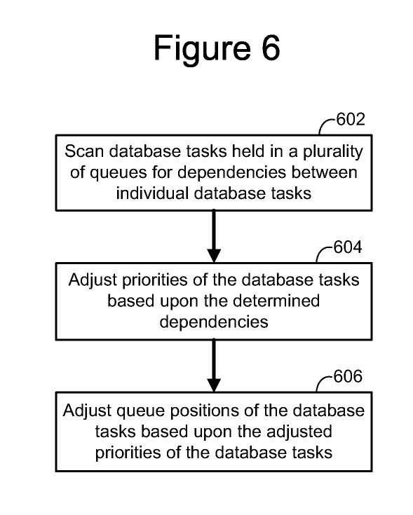

FIG. 6 illustrates the computer executed steps of an additional process for resolving database task dependencies in task queues. In step 602 of FIG. 6, database tasks held in a plurality of queues are scanned for dependencies between individual database tasks. In one embodiment, higher priority database tasks are scanned for input dependencies and the lower priority database tasks are scanned for outputs. These inputs and outputs are compared to see if there is a match. In other words, it is determined whether there is an output of a particular low priority database task that provides an input that a higher priority database task is waiting for. In step 604 of FIG. 6, previously determined priorities of the database tasks are adjusted based upon the determined dependencies. In step 606 of FIG. 6, queue positions of the database tasks may be adjusted based upon the adjusted priorities of the database queues.

Although certain preferred embodiments and methods have been disclosed herein, it will be apparent from the foregoing disclosure to those skilled in the art that variations and modifications of such embodiments and methods may be made without departing from the spirit and scope of the disclosure. It is intended that the disclosure shall be limited only to the extent required by the appended claims and the rules and principles of applicable law.

What is claimed is:

1. A database system comprising:
a database server operable to define a priority for each of a plurality of database tasks; and
a database storage system comprising a storage processing node and a queue, wherein the storage processing node is operable to receive database tasks from the database server and place them into the queue based upon their priority, wherein the storage processing node is further operable to determine whether there are dependencies between a first database task and a second database task with a defined higher priority than the first database task, such that the storage processing node is further operable to place the first database task into a same queue as the second database task when there is a determined dependency between the first database task and the second database task, wherein the second database task is dependent upon the first database task when an input of the second database task is waiting for an output of the first database task.

2. The database system of claim 1, wherein the queue comprises a low priority queue and a high priority queue.

3. The database system of claim 1, wherein the storage processing node is further operable to set a flag so that the first database task is placed into a front of the queue when a dependency between the first database task and the second database task is determined.

4. The database system of claim 1, wherein the database storage system comprises a plurality of storage disks, each operable to store database tables.

5. The database system of claim 1, wherein the storage processing node comprises a processor operable to perform local database processing and to evaluate database tasks for dependency with other database tasks.

6. The database system of claim 1, wherein a database task is one of a read-only task and a read/write task.

7. The database system of claim 1, wherein a database task is at least one of a:
data query;
data update;
data insertion; and
database table modifications.

8. A method for managing database resources, the method comprising:
defining a priority for a first database task;
determining whether there is a second database task with a priority higher than the priority of the first database task that is dependent upon the first database task, wherein the second database task is dependent upon the first database task when an input of the second database task is waiting for an output of the first database task; and
setting a new priority for the first database task that is higher than a priority of the second database task when the second database task depends upon the first database task.

9. The method of claim 8 further comprising placing the first database task into a first queue of a plurality of queues based upon the priority of the first database task.

10. The method of claim 9, wherein the plurality of queues comprises a high priority queue and a low priority queue.

11. The method of claim 9, wherein placing the first database task into the first queue comprises placing the first database task into a same queue as the second database task when the second database task depends upon the first database task.

12. The method of claim 8, wherein setting the new priority comprises setting a flag so that the first database task is placed into a front of a queue when the second database task depends upon the first database task.

13. The method of claim 9 further comprising:
scanning database tasks held in the plurality of queues for dependencies between the database tasks;
adjusting priorities of the database tasks based upon the determined dependencies; and
adjusting queue positions of the database tasks based upon the adjusted priorities of the database tasks.

14. The method of claim 8, wherein a database task is one of a read-only task and a read/write task.

15. The method of claim 8, wherein a database task is at least one of a:
data query;
data update;
data insertion; and
database table modifications.

16. A method for managing database resources, the method comprising:
scanning database tasks held in a plurality of queues for dependencies between the database tasks, wherein a second database task is dependent upon a first database task when an input of the second database task is waiting for an output of the first database task;
adjusting priorities of the database tasks based upon the determined dependencies; and
adjusting queue positions of the database tasks based upon the adjusted priorities of the database tasks.

17. The method of claim 16, wherein adjusting queue positions of the database tasks comprises:
moving the first database task to a same queue as the second database task when the second database task is dependent upon the first database task; and
setting a flag so that the first database task is placed into a front of a queue.

18. The method of claim 16, wherein the plurality of queues comprises a high priority queue and a low priority queue.

19. The method of claim 16, wherein a database task is one of a read-only task and a read/write task.

20. The method of claim 16, wherein a database task is at least one of a:
data query;
data update;
data insertion; and
database table modifications.
